(19) United States
(12) Patent Application Publication
(10) Pub. No.: US 2009/0208646 A1
(43) Pub. Date: Aug. 20, 2009

(54) METHOD FOR THE PRODUCTION OF A CHAFE RESISTANT OVERLAY

(75) Inventors: Reinhard Kreuder, Bad Berleburg (DE); Klaus Fischer, Bad Berleburg (DE)

Correspondence Address: MCCORMICK, PAULDING & HUBER LLP, CITY PLACE II, 185 ASYLUM STREET, HARTFORD, CT, 06103, US

(73) Assignee: Dekor-Kunststoffe GmbH, Erndtebrueck (DE)

(21) Appl. No.: 12/369,059

(22) Filed: Feb. 11, 2009

(30) Foreign Application Priority Data
Feb. 12, 2008 (DE) 10 2008 008 808.0

(51) Int. Cl. B05D 3/00; B05C 13/00

(52) U.S. Cl. 427/209; 118/56

(57) ABSTRACT

The invention relates to a method (100) for the production of an overlay, in particular for laminates. For this, firstly an overlay base paper (10) is impregnated in the usual manner and is coated on one side with a resin/coarse corundum application. In order to endow the overlay with additional characteristics, such as for example chafe resistance on the surface, in a further wet-in-wet application step a coating substance (29) is applied on the opposite side and is dosaged by a wiper (31).

### CROSS REFERENCE TO RELATED APPLICATION

This application claims the benefit of German Application No. 102008008808.0, filed Feb. 12, 2008, the disclosure of which is herein incorporated by reference in its entirety.

### FIELD OF THE INVENTION

The invention relates to a method for the production of a chafe resistant overlay, in particular for laminates.

The invention further relates to an impregnating device to carry out this method.

### BACKGROUND OF THE INVENTION

In the field of the production of floor laminates, overlay papers are used, the purpose of which is to produce on the actual decorative layer a highly transparent and, at the same time, hard-wearing surface. Hard-wearing was understood hitherto to mean a high chemical resistance and water-proof characteristic of the surface, in addition the capability of counteracting mechanical wear and hence above all preventing damage to the decorative layer.

The former is achieved through the use of melamine formaldehyde resins, which produce a compact, resistant surface through pressing and resin condensation. The mechanical resistance is ensured through the introduction of hard particles such as, for example, corundum granules, into the resin matrix.

The surface of the finished laminate is produced by the impression of the pressing plate surface in the pressing operation. In order to prevent damage to the pressing plate by corundum in the overlay during the pressing process, this is covered by a cellulose layer.

Such overlays are produced today principally by the fluid overlay method, in which the quantity of corundum (hereinafter always named coarse corundum) necessary to achieve the abrasion resistant characteristics is obtained by washing and dosaging a resin coarse corundum dispersion onto an overlay base paper.

The prior art is a method in which an overlay base paper, generally with an area weight of 25-35 g/m², is unwound from a roll. In the first step, a resin solution is then applied on one side onto this paper web by means of a bucket roller, so that the cellulose fibres of the paper can fill with the resin solution and as much air as possible from the fibre capillaries is replaced with resin.

The paper is then guided by means of deflector rollers over a longer “breathing section”, in which the paper web swells through the uptake of moisture, then the web is guided through a second resin tank in which further resin is received into the paper structure.

After this so-called impregnating of the paper web in the core, the paper web which is now saturated with resin solution is guided through between two dosaging rollers which form a gap with a defined width and hence control the application weight of the resin solution on the paper web.

In the next method step, a resin/coarse corundum dispersion is applied on one side onto the paper web which is already saturated with resin, its application weight then being determined and adjusted by a further roller gap.

After the method known hitherto, the paper web which is thus resined and provided on one side with coarse corundum is dried to a defined residual moisture in a drying duct constructed as a floating web drier.

If in addition to its function as transparent and abrasion resistant covering layer in the laminate floor, the overlay is to obtain further surface characteristics (e.g. chafe resistance of the surface), then according to the methods known hitherto from the prior art provision is made that a corresponding additive is added “in the batch”. This means that the entire quantity of resin must undergo a modification within the framework of the core impregnation. However, the disadvantage results through this that an additive which is only intended to develop its effect on the surface, must be used in large quantities in the resin core for the development of the effect, with the consequence that this leads to the overlay which is to be produced being made more expensive to a not inconsiderable extent.

Alternatively, in the methods known hitherto, the paper web which is supplied to the drying device in its partially dried state is provided with an additional application on the upper side and namely such that the partially dried web in the middle of the drying device, which is present in the form of a drying duct, is given an additional application on the upper side by means of an application unit. The application unit can be, for example, a raster roll or a wiper device. However, the application by the latter method by means of the raster roll is generally at the expense of the production speed. In addition, it has been found that the raster roll application is only possible in the case of an already partially dried web and a wet-in-wet application can not be brought about by this method.

### SUMMARY OF THE INVENTION

Proceeding from the presented disadvantages and acknowledging the indicated prior art in methods of the type mentioned in the introduction, the present invention is therefore based on the problem of providing a method in which through a further wet-in-wet application step on one side additives can be applied on the surface, which give the overlay further important characteristics.

The invention solves this problem.

Advantageous developments of the invention are also described.

According to the invention—for example after the impregnating of the paper web and the application of the resin/coarse corundum dispersion on one side—a wet-in-wet application of a resin/fine corundum dispersion and dosaging thereof takes place on the opposite side of the paper web. Instead of the resin/fine corundum dispersion, any other resin/additive dispersion can also be applied, in order to achieve a particular effect in the surface.

The wet-in-wet application and dosaging of the resin/additive dispersion is achieved in that the resin/additive dispersion is guided with sufficient pressure into the gap between wipers and is applied onto the paper web. The dosaging of the applied dispersion takes place via a rotating wiper which can be constructed as a smoothing or wire wiper and can rotate either in the opposite or in the same direction. The dosaged quantity depends on the wiper surface, the direction and speed of rotation.

A uniform abutment of the paper web and hence a uniform application of the resin/additives dispersion are achieved by a light pressing of the paper web onto the wiper, which is controlled by the intensity of the wrapping around of the application device.

Through the dosaging method by means of a wiper forming the basis of the method according to the invention, it is ensured that small application quantities of a coating substance can be applied uniformly wet-in-wet on one side. In addition, a great advantage of the invention is to be seen in that the entire drying device is available for an efficient paper web drying.

The wet-in-wet application in addition ensures that between the already applied resin and the new application layer, no boundary surfaces can occur, as can occur in the application onto a partially dried resin surface.

In addition, within the framework of the invention an impregnating device is provided for carrying out the method.

### BRIEF DESCRIPTION OF THE DRAWINGS

An example embodiment of the invention is described below with the aid of the figures, in which are shown in diagrammatic illustration:

FIG. 1 an illustration of the method according to the invention; and

FIG. 2 a view of the application and dosaging of the coating substance according to the invention.

### DESCRIPTION OF THE PREFERRED EMBODIMENTS

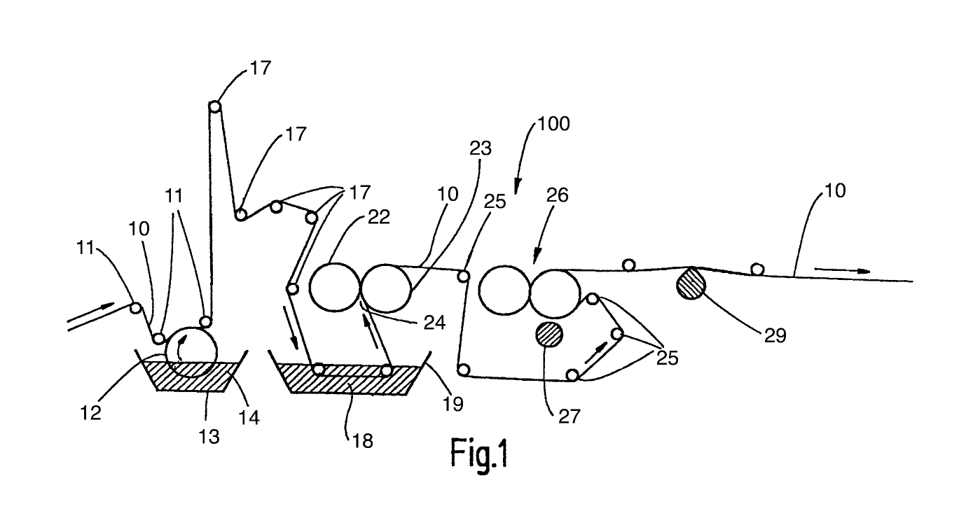

The method 100 illustrated diagrammatically in FIG. 1 serves for the production of resin-impregnated papers, which are to be endowed in addition with particular functionalities. In the embodiment shown here, the method 100 serves in particular for the production of abrasion resistant overlays of laminate floors.

The method 100 begins with the unwinding of a so-called overlay base paper from a roll which is not illustrated here. The paper web 10 is then pressed by the rollers 11 onto the moistening roller 12, which applies the impregnating medium 14 from the first resin tank 13 in the form of a resin onto the paper web 10.

The paper web 10, coated on one side, is then guided further by means of the deflector rollers 17 and in this time can swell by taking up moisture and resin into the fibre structure of the paper.

By subsequent immersion of the paper web 10 in the second resin tank 19, further impregnating medium 18 is taken up in the form of resin. The quantity of resin thus applied onto the paper web 10 is controlled by the gap width of the roller gap 24 between the dosaging rollers 22 and 23.

In order to produce an abrasion resistant overlay, in a further method step the thus impregnated paper web 10 is guided by means of the deflector rollers 25 past a washing nozzle, by means of which a resin/coarse corundum dispersion 27 is washed onto the paper web 10 in excess. The desired application weight of the resin/corundum dispersion is then set by means of the gap width between the dosaging rollers 26.

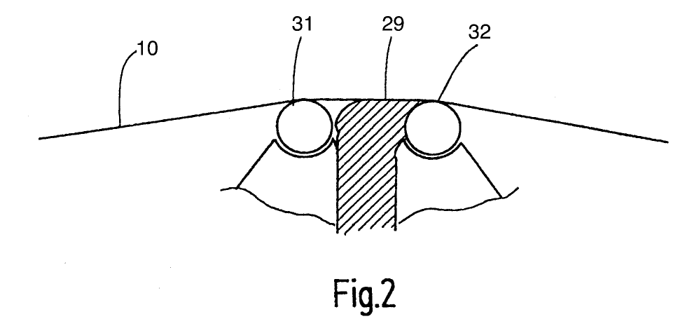

In order to obtain a chafe resistant overlay, as described above after the application and dosaging of the coarse corundum dispersion on the opposite side of the paper a coating substance 29 is applied in the form of a fine corundum dispersion and is dosaged by means of the wiper 32 (see also FIG. 2).

The coated paper web 10 is then dried and is adjusted with regard to residual moisture so that an overlay is obtained which is able to be processed well.

The present invention is not limited in its embodiment to the preferred example embodiments indicated above. Rather, a number of variants are conceivable, which also make use of the illustrated solution with basically differently developed embodiments. Therefore, the wipers 31, 32 can have various developments. Also, different dosaging devices can be used as pairs of rollers. In addition, the method is not restricted to the production of abrasion resistant overlays with an additive coat on the upper side. Rather, the method can also be used for the production of non abrasion resistant overlays or other resin-impregnated papers, which are to be additionally equipped with functionalities.

### LIST OF REFERENCE NUMBERS

100 method
10 paper web
11 deflector roller
12 moistening roller
13 first resin tank
14 impregnating medium (resin)
17 deflector roller
18 impregnating medium (resin)
19 second resin tank
22 dosaging roller
23 dosaging roller
24 roller gap
25 deflector roller
26 dosaging roller
27 resin/coarse corundum dispersion
28 deflector rollers
29 coating substance
31 wiper
32 wiper

1. Method (100) for the production of an overlay, in particular for laminates, with the following method steps:
a) Unrolling of an overlay base paper from a roll for the purpose of obtaining a paper web (10);
b) Moistening of the paper web (10) on one side with an impregnating medium (14);
c) Impregnating the paper web (10) in the core thereof and dosaging of the application of an impregnating medium provided for the impregnation;
d) Wet-in wet application of a coarse corundum/resin dispersion (27) on one side onto the paper web (10) and dosaging of the application;
e) Opposite wet-in-wet application of a coating substance (29) onto the paper web (10);
f) Dosaging of the applied coating substance (29) by a dosaging device (30), in particular by at least one wiper (31, 32), to the desired application weight;
g) Drying the paper web (10) using an entire drying duct length and capacity.

2. Method according to claim 1, characterized in that after impregnating of the paper web (10), a washing of the paper web (10) on one side takes place by a resin/coarse corundum dispersion (27).

3. Method according to claim 1, characterized in that the wet-in-wet application of the coating substance (29) on one side takes place in the form of a resin/additive application.

4. Method according to claim 1, characterized in that the coating substance (29) is guided between two wipers (31, 32).

5. Method according to claim 1, characterized in that the underside of the paper web (10) is brought against the wiper (31, 32) and is wiped off by the wiper (31, 32).

6. Method according to claim 1, characterized in that the coating substance (29) is applied distributed uniformly.

7. Method according to claim 1, characterized in that the coating substance (29) is supplied to the paper web (10) through an inlet gap.

8. Impregnating device to carry out the method according to claim 1.
